(19) United States
(12) Patent Application Publication
(10) Pub. No.: US 2026/0289919 A1
(43) Pub. Date: Sep. 24, 2026

(54) ENSURING A SMOOTH USER EXPERIENCE IN A MULTI-USER AUGMENTED REALITY SYSTEM

(71) Applicant: UNIVERSITY OF HOUSTON SYSTEM, Houston, TX (US)

(72) Inventors: Xin Fu, Houston, TX (US); Aamir Bader Shah, Houston, TX (US); Yu Wen, Houston, TX (US); Jiefu Chen, Houston, TX (US); Xuqing Wu, Sugar Land, TX (US)

(73) Assignee: UNIVERSITY OF HOUSTON SYSTEM, Houston, TX (US)

(21) Appl. No.: 19/477,522

(22) PCT Filed: Apr. 21, 2024
(86) PCT No.: PCT/US2024/025616

§ 371 Date: Oct. 22, 2025

Related U.S. Application Data
(60) Provisional application No. 63/461,261, filed on Apr. 22, 2023.

(51) Int. Cl. G06T 19/00; G06T 15/20; G06T 17/00

(52) U.S. Cl. CPC G06T 19/006; G06T 15/20; G06T 17/005; G06T 2219/024

(57) ABSTRACT

A method, computer program product and system for ensuring a smooth user experience in a multi-user augmented reality system. A computing device (“master”) shares a quadtree data structure of an image with a virtual 3D object with another computing device (“slave”), which inputs the quadtree data structure into a machine learning (ML) model to obtain ML results which is used by the slave to render an image of the virtual 3D object in the field of view of the slave, which may experience slight offset. The slave transforms the rendered image into a quadtree data structure, which is shared with the master along with the ML results. The master then inputs the received information into its ML model. The ML results from the ML model may include correction values, which may be applied to the image previously rendered by the master. This iterative process continues until corrections are not necessary.

### CROSS REFERENCE TO RELATED APPLICATIONS

This application claims priority to U.S. Provisional Patent Application Ser. No. 63/461,261 entitled “Ensuring a Smooth User Experience in a Multi-User Augmented Reality System,” filed on Apr. 22, 2023, which is incorporated by reference herein in its entirety.

### TECHNICAL FIELD

The present disclosure relates generally to augmented reality systems, and more particularly to improving the operational performance of a multi-user augmented reality system using mobile computing devices by using lightweight machine learning models utilizing a quadtree algorithm and having the mobile computing devices communicate with each other through peer-to-peer communication.

### BACKGROUND

Augmented reality (AR) is an interactive experience that combines the real world and computer-generated content. The content can span multiple sensory modalities, including visual, auditory, haptic, and somatosensory. AR can be defined as a system that incorporates three basic features: a combination of real and virtual worlds, real-time interaction, and accurate three-dimensional (3D) registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment. In this way, augmented reality alters one's ongoing perception of a real-world environment, whereas, virtual reality completely replaces the user's real-world environment with a simulated one.

A multi-user AR system allows multiple users to interact with virtual objects overlaid on real-world space. This has led to the development of various useful applications, such as multiplayer gaming, medical imaging, classroom education, navigation, robotics, autonomous vehicle, virtual exhibition in museums, etc. However, multi-user AR itself is a computation-intensive task requiring low latency and high accuracy for ensuring a smooth user experience. To address this challenge, the commercial multi-user AR frameworks, such as Google ARCore® and Apple ARKit®, utilize cloud services to offload computation-intensive tasks. This includes offloading three-dimensional (3D) point clouds required for localization of users through the simultaneous localization and mapping (SLAM) algorithm. However, using cloud services can cause noticeable delays in latency and communications overheads. The long delay causes inaccurate rendering results as the user's position may have changed during such a long processing time, and the user may see an object as per the user's previous position.

As a result, current multi-user AR frameworks suffer from high latency and high energy consumption which diminish the AR user experience.

### SUMMARY

In one embodiment of the present disclosure, a computer-implemented method for improving operational performance of a multi-user augmented reality system comprises transforming a first image with a virtual three-dimensional object into a first quadtree data structure. The method further comprises sharing the first quadtree data structure with a second computing device which is inputted into a machine learning model on the second computing device to obtain a first machine learning result which is used by the second computing device to render a second image of the virtual three-dimensional object. The method additionally comprises receiving the second image as a second quadtree data structure as well as the first machine learning result from the second computing device. Furthermore, the method comprises inputting the second quadtree data structure and the first machine learning result into a machine learning model on a first computing device to obtain a second machine learning result which includes correction values for modifying the first image. Additionally, the method comprises updating a rendering of the first image using the correction values.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a communication system for practicing the principles of the present disclosure;

FIG. 2 illustrates the basic components of a mobile computing device in accordance with an embodiment of the present disclosure;

FIGS. 3A-3B are a flowchart of a method for performing collaborative multi-user AR while eliminating the need for cloud offloading in accordance with an embodiment of the present disclosure;

FIG. 4 illustrates performing image segmentation and depth estimation by the master and slave in accordance with an embodiment of the present disclosure;

FIG. 5 illustrates rendering a virtual three-dimensional object on top of the object of interest by the master which is shared with the slave as a quadtree data structure in accordance with an embodiment of the present disclosure;

FIG. 6 illustrates the slave sharing the resulting rendered image as a quadtree data structure along with the machine learning results with the master in accordance with an embodiment of the present disclosure; and

FIG. 7 illustrates the master applying corrections to the rendered image which is shared with the slave as a quadtrec data structure along with the machine learning results in accordance with an embodiment of the present disclosure.

### DETAILED DESCRIPTION

As stated above, augmented reality (AR) is an interactive experience that combines the real world and computer-generated content. The content can span multiple sensory modalities, including visual, auditory, haptic, and somatosensory. AR can be defined as a system that incorporates three basic features: a combination of real and virtual worlds, real-time interaction, and accurate three-dimensional (3D) registration of virtual and real objects. The overlaid sensory information can be constructive (i.e., additive to the natural environment), or destructive (i.e., masking of the natural environment). This experience is seamlessly interwoven with the physical world such that it is perceived as an immersive aspect of the real environment. In this way, augmented reality alters one's ongoing perception of a real-world environment, whereas, virtual reality completely replaces the user's real-world environment with a simulated one.

A multi-user AR system allows multiple users to interact with virtual objects overlaid on real-world space. This has led to the development of various useful applications, such as multiplayer gaming, medical imaging, classroom education, navigation, robotics, autonomous vehicle, virtual exhibition in museums, etc. However, multi-user AR itself is a computation-intensive task requiring low latency and high accuracy for ensuring a smooth user experience. To address this challenge, the commercial multi-user AR frameworks, such as Google ARCore® and Apple ARKit®, utilize cloud services to offload computation-intensive tasks. This includes offloading three-dimensional (3D) point clouds required for localization of users through the simultaneous localization and mapping (SLAM) algorithm. However, using cloud services can cause noticeable delays in latency and communications overheads. The long delay causes inaccurate rendering results as the user's position may have changed during such a long processing time, and the user may see an object as per the user's previous position.

As a result, current multi-user AR frameworks suffer from high latency and high energy consumption which diminish the AR user experience.

The embodiments of the present disclosure provide a means for reducing the computational costs involved in performing collaborative multi-user AR while eliminating the need for cloud offloading. In one embodiment, the need for cloud offloading is eliminated by utilizing peer-to-peer communication and ensuring a low data size generation through the use of a quadtree data structure. “Peer-to-peer” communication, as used herein, refers to the transmission between two peer devices over a network. A quadtree is a tree data structure in which each internal node has exactly four children. Quadtrees are the two-dimensional analog of octrees and are used to partition a two-dimensional space by recursively subdividing it into four quadrants or regions. The data associated with a leaf cell varies by application, but the leaf cell represents a “unit of interesting spatial information.” As a result, the principles of the present disclosure meet the low latency and energy requirements and achieve high accuracy to ensure smooth user experience in a multi-user augmented reality system. A further discussion regarding these and other features is provided below.

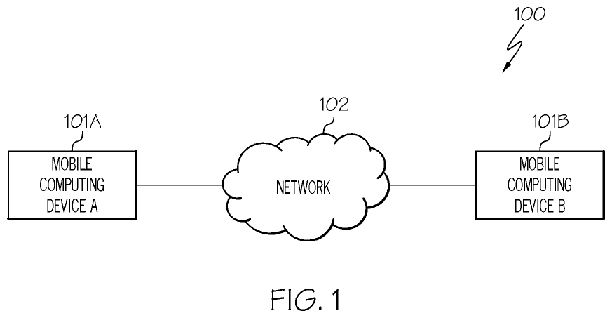

Referring now to the Figures in detail, FIG. 1 illustrates an embodiment of the present disclosure of a communication system 100 for practicing the principles of the present disclosure. Communication system 100 includes at least a first mobile computing device 101A (identified as “Mobile Computing Device A” in FIG. 1) and a second mobile computing device 101B (identified as “Mobile Computing Device B” in FIG. 1) interconnected via a network 102. Mobile computing devices 101A, 101B may collectively or individually be referred to as mobile computing devices (or simply mobile devices) 101 or mobile computing device (or simply mobile device) 101.

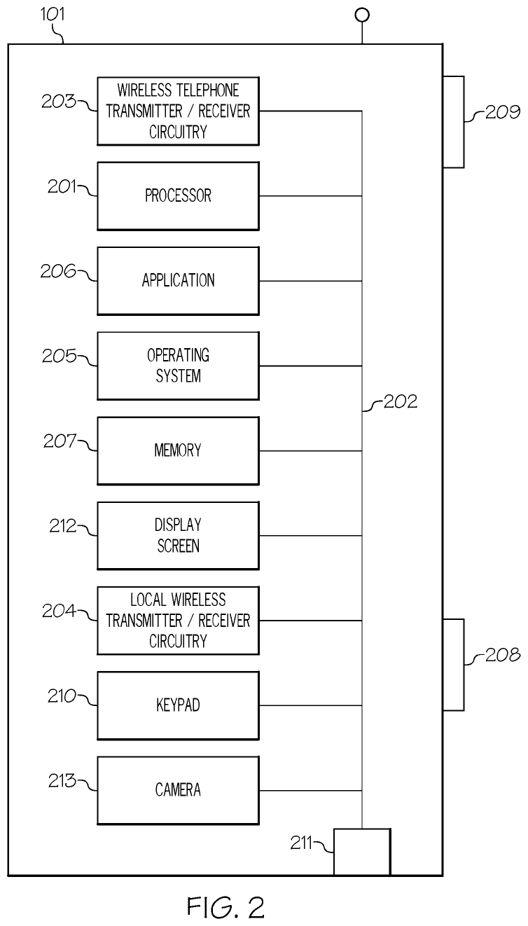

A mobile computing device 101, as used herein, refers to a computer small enough to hold and operate in the hand. Mobile computing devices 101 typically have a flat liquid crystal display or organic light emitting diode screen, a touchscreen interface and digital or physical buttons. Examples of such mobile computing devices 101 include, but not limited to, a mobile phone, a cellular phone, a smartphone, a personal digital assistance (PDA), a portable computing unit, etc. A description of the basic components of such a mobile computing device 101 is discussed below in connection with FIG. 2.

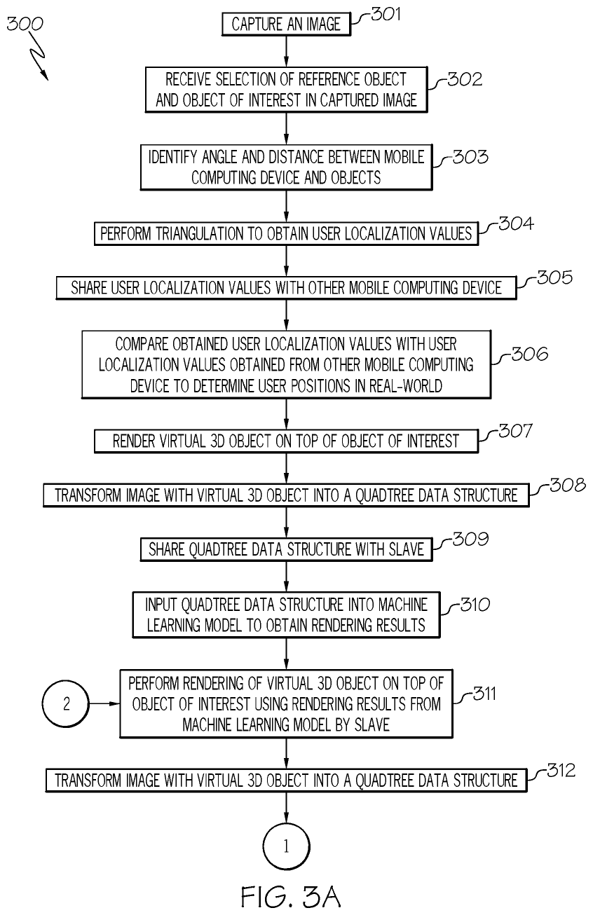

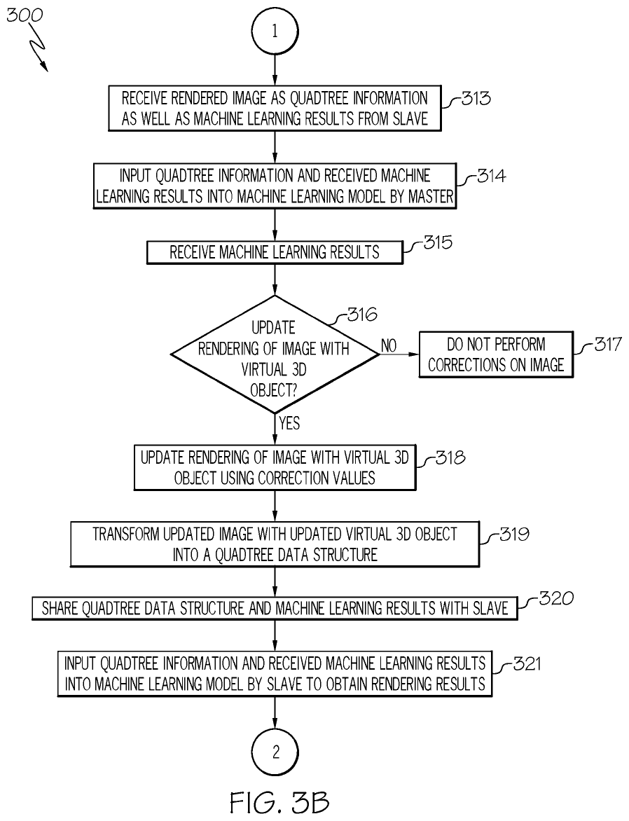

As discussed above, current multi-user AR frameworks suffer from high latency and high energy consumption which diminish the AR user experience. In one embodiment, mobile devices 101 implement an AR framework that reduces the computational costs involved in performing collaborative multi-user AR while eliminating the need for cloud offloading. In connection with such an AR framework, one of the mobile computing devices 101 is referred to herein as the “master” and the other mobile computing devices 101 are referred to herein as the “slave.” The “master,” as used herein, refers to mobile computing device 101 that is the initiator of the process in performing AR as discussed herein; whereas, the other mobile computing devices 101 are the “slave.” A further discussion regarding the process in performing AR using the AR framework of the present disclosure is provided below in connection with FIGS. 3A-3B and 4-7.

Additionally, network 102 may be, for example, a mobile network, a cellular network, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

System 100 is not to be limited in scope to any particular network architecture. System 100 may include any number of mobile computing devices 101 and networks 102.

A discussion regarding the basic components of mobile computing device 101 is provided below in connection with FIG. 2.

FIG. 2 illustrates the basic components of mobile computing device 101 in accordance with an embodiment of the present disclosure.

Referring to FIG. 2, mobile computing device 101 has a processor 201 connected to various other components by a system bus 202.

Mobile computing device 101 further includes transmitter/receiver circuitry 203 configured to wirelessly send and receive signals to and from network 102 (FIG. 1). Mobile computing device 101 also includes local wireless transmitter/receiver circuitry 204 configured to wirelessly send and receive short range signals, such as Bluetooth, infrared or Wi-Fi.

Mobile computing device 101 additionally includes an operating system 205 that runs on processor 201 and provides control and coordinates the functions of the various components of FIG. 2. An application 206 in accordance with the principles of the present disclosure runs in conjunction with operating system 205 and provides calls to operating system 205 where the calls implement the various functions or services to be performed by application 206. Application 206 of mobile computing device 101 may include, for example, a program for ensuring a smooth user experience in a multi-user augmented reality system as discussed further below in connection with FIGS. 3A-3B and 4-7.

Mobile computing device 101 further includes a memory 207 that is configured to store the requisite logic and parameters to control the transmitter/receiver circuitry 203, 204 and control the other functions of mobile computing device 101. Memory 207 is generally integrated as part of the mobile device circuitry, but may, in some embodiments, include a removable memory, such as a removable disk memory, integrated circuit (IC) memory, a memory card, or the like. Processor 201 and memory 207 also implement the logic and store the settings, preferences, and parameters for mobile computing device 101. It should be noted that software components including operating system 205 and application 206 may be loaded into memory 207, which may be mobile computing device's 101 main memory for execution.

Mobile computing device 101 also has a microphone 208 and speaker 209 for the user to speak and listen to callers. Speaker 209 may represent multiple speakers, at least some of which are configured to alert the user to incoming calls or messages. Mobile computing device 101 further includes a keypad 210 for dialing telephone numbers and entering data.

Furthermore, mobile computing device 101 may be configured with a data input/output (I/O) port 211 for downloading data, applications, programs, and other information. In addition, mobile computing device 101 typically includes a display screen 212 for displaying messages and information about incoming calls or other features of mobile computing device 101 that use a graphic display.

Additionally, mobile computing device 101 utilizes a camera 213 (e.g., monocular camera) for capturing images. A monocular camera, as used herein, is a single lens camera which is capable of capturing images.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As stated above, a multi-user AR system allows multiple users to interact with virtual objects overlaid on real-world space. This has led to the development of various useful applications, such as multiplayer gaming, medical imaging, classroom education, navigation, robotics, autonomous vehicle, virtual exhibition in museums, etc. However, multi-user AR itself is a computation-intensive task requiring low latency and high accuracy for ensuring a smooth user experience. To address this challenge, the commercial multi-user AR frameworks, such as Google ARCore® and Apple ARKit®, utilize cloud services to offload computation-intensive tasks. This includes offloading three-dimensional (3D) point clouds required for localization of users through the simultaneous localization and mapping (SLAM) algorithm. However, using cloud services can cause noticeable delays in latency and communications overheads. The long delay causes inaccurate rendering results as the user's position may have changed during such a long processing time, and the user may see an object as per the user's previous position. As a result, current multi-user AR frameworks suffer from high latency and high energy consumption which diminish the AR user experience.

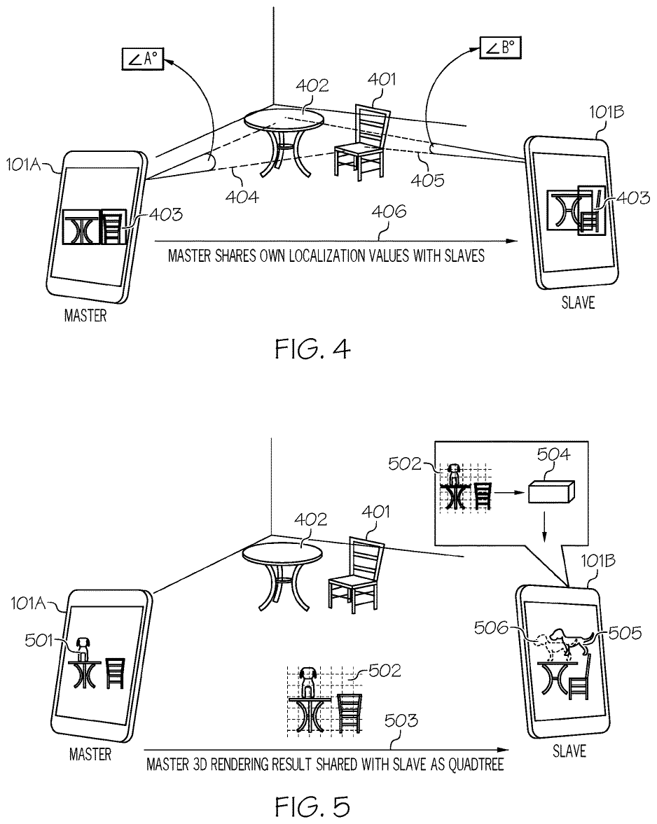

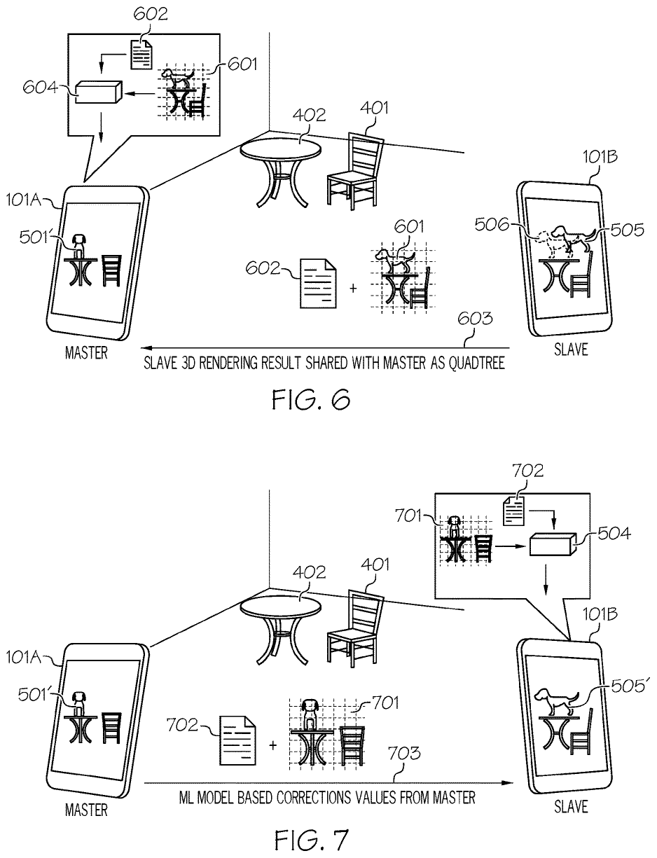

The embodiments of the present disclosure provide a means for reducing the computational costs involved in performing collaborative multi-user AR while eliminating the need for cloud offloading by utilizing peer-to-peer communication and ensuring a low data size generation through the use of a quadtree data structure as discussed below in connection with FIGS. 3A-3B and 4-7. FIGS. 3A-3B arc a flowchart of a method for performing collaborative multi-user AR while eliminating the need for cloud offloading in accordance with an embodiment of the present disclosure. FIG. 4 illustrates performing image segmentation and depth estimation by the master and slave. FIG. 5 illustrates rendering a virtual three-dimensional object on top of the object of interest by the master which is shared with the slave as a quadtree data structure. FIG. 6 illustrates the slave sharing the resulting rendered image as a quadtree data structure along with the machine learning results with the master. FIG. 7 illustrates the master applying corrections to the rendered image which is shared with the slave as a quadtree data structure along with the machine learning results.

As stated above, FIGS. 3A-3B are a flowchart of a method 300 for performing collaborative multi-user AR while eliminating the need for cloud offloading in accordance with an embodiment of the present disclosure.

Referring to FIG. 3A, in conjunction with FIGS. 1-2, in step 301, mobile computing device 101 (e.g., mobile computing device 101A) captures an image (e.g., image of a desk and a table) using camera 213 (e.g., monocular camera).

In step 302, mobile computing device 101 (e.g., mobile computing device 101A) receives the selection of a reference object and an object of interest in the captured image, such as from the user of mobile computing device 101. A “reference object,” as use herein, refers to an object in an image that allows referencing to other objects in the image. An “object of interest,” as used herein, refers to the object in the image upon which a virtual three-dimensional object will be rendered. An “image,” as used herein, refers to a visual representation of something, such as a visual representation of objects in a room captured by camera 213, such as a monocular camera (single lens camera).

In one embodiment, such a selection is made by the user of mobile computing device 101 via the graphical user interface of mobile computing device 101, such as highlighting or placing a box around the reference object and the object of interest in the image captured by camera 213 (e.g., monocular camera) of mobile computing device 101.

In one embodiment, both the master and the slave each receive the selection of the reference object and the object of interest. As discussed above, the “master,” as used herein, refers to mobile computing device 101 that is the initiator of the process in performing AR as discussed herein; whereas, the other mobile computing devices 101 are the “slave.”

In step 303, mobile computing device 101 identifies the angle and distance between mobile computing device 101 and the objects (reference object and the object of interest) in the captured image (e.g., image of a table and a chair) as illustrated in FIG. 4. In one embodiment, both the master and the slave perform such identification using instance segmentation and depth estimation. As discussed above, the “master,” as used herein, refers to mobile computing device 101 that is the initiator of the process in performing AR as discussed herein; whereas, the other mobile computing devices 101 are the “slave.”

FIG. 4 illustrates performing image segmentation and depth estimation by the master and slave in accordance with an embodiment of the present disclosure.

Referring to FIG. 4, mobile computing device 101A corresponds to the master and mobile computing device 101B corresponds to the slave. Furthermore, as shown in FIG. 4, reference object 401 corresponds to the chair and the table corresponds to the object of interest 402. A “reference object,” as use herein, refers to an object in an image that allows referencing to other objects in the image. An “object of interest,” as used herein, refers to the object in the image upon which a virtual three-dimensional object will be rendered. An “image,” as used herein, refers to a visual representation of something, such as a visual representation of objects in a room captured by camera 213, such as a monocular camera (single lens camera).

In one embodiment, both master 101A and slave 101B perform instance segmentation and depth estimation to identify the angle and distance between mobile computing device 101 and the objects (reference object 401 and object of interest 402). “Instance segmentation,” as used herein, refers to a form of image segmentation that deals with detecting instances of objects and demarcating their boundaries. Instance segmentation is a technique of detecting, segmenting, and classifying every individual object in an image. In one embodiment, instance segmentation is R-CNN (region-based convolutional neural network) driven or FCN (fully convolutional network) driven.

In one embodiment, a classifier is trained to predict each pixel's (pixel in the captured image) likelihood score of the pixel belonging to a category. In one embodiment, k2 position-sensitive score maps that respond to k×k evenly portioned cells of the object are used to introduce the translation variant properly. Each score then represents the likelihood of the pixel belonging to an object instance at a relative position. For example, a pixel corresponding to a person can be a foreground for a person in one semantic position and a background for another person (instance). As a result, object detection and segmentation are carried out jointly and simultaneously.

In one embodiment, mask R-CNN is used for instance segmentation with three outputs. In one embodiment, it has a class label and a bounding box offset and a third branch that outputs the object mask requiring extraction of a spatial layout of an object.

In one embodiment, mobile computing device 101 uses various software tools for instance segmentation, including, but not limited to, Supervisely, CVAT, Viso Suite, etc.

The results of such instance segmentation 403 are illustratively shown in FIG. 4.

Depth estimation, as used herein, refers to the task of measuring the distance of each pixel in an image (pixel in the captured image) relative to camera 213 (e.g., monocular camera) of mobile computing device 101. That is, depth estimation is the task of predicting the depth of the objects present in an image. In one embodiment, depth estimation is performed using visual cues and disparate camera parameters. In one embodiment, BDE (binary differential evolution) and MVDE (multi-view depth estimation) methods are used to obtain depth information. In one embodiment, mobile computing device 101 uses various software tools for performing depth estimation, including, but not limited to, MiDaS neural networks, Open VINO®, Vitis™ AI, etc.

In one embodiment, upon performing instance segmentation and depth estimation, mobile computing devices 101 identify an angle and distance between mobile computing device 101 and the objects, such as reference object 401 and object of interest 402 (“objects”) as shown in FIG. 4. For example, as shown in FIG. 4, ∠A° corresponds to the angle between the objects and mobile computing device 101A from the master's field of view (field of view of mobile computing device 101A) and ∠B° corresponds to the angle between the objects and mobile computing device 101B from the slave's field of view (field of view of mobile computing device 101B).

Furthermore, as illustrated in FIG. 4, dashed lines 404 indicate the distance of the objects from the master (mobile computing device 101A). Dashed lines 405 indicate the distance of the objects from the slave (mobile computing device 101B).

Returning to FIG. 3A, in conjunction with FIGS. 1-2 and 4, in step 304, each mobile computing device 101 (e.g., master and slave) performs triangulation using the identified angle and distance between the objects and the mobile computing device 101 to obtain user localization values. Triangulation, as used herein, refers to the process of determining the location of a point (user of mobile computing device 101) by forming triangles to the point from known points (e.g., reference object 401 and object of interest 402). User localization values, as used herein, refer to the location with respect to the local environment (e.g., user located approximately 5 feet to the left of the chair). Mobile computing device 101 uses various software tools for performing triangulation using the identified angle and distance between the objects and mobile computing device 101 to obtain user localization values, including, but not limited to, OpenCV®, TensorFlow®, Keras®, PyTorch®, etc.

In step 305, each computing device 101 (e.g., master) shares such user localization values with the other mobile computing device 101 (e.g., slave), such as via peer-to-peer (P2P) communication as illustrated by element 406 of FIG. 4. “Peer-to-peer” communication, as used herein, refers to the transmission between two peer computers over a network.

In step 306, each computing device 101 (e.g., master) compares the obtained user localization values with the user localization values obtained from the other mobile computing device 101 (e.g., slave) to determine user positions (e.g., coordinate positions, such as X, Y, and Z coordinate positions), such as the positions of the users of mobile computing devices 101, in the real world. For example, in one embodiment, the user positions (positions of the users of mobile computing devices 101) in the real world are obtained using the user localization values from the mobile computing devices 101 (master and slave) by determining the distances of the objects (e.g., reference object 401, object of interest 402) with respect to mobile devices 101A, 101B using such user localization values and then mapping such differences onto a coordinate grid thereby allowing the user positions (coordinate positions, such as X, Y, and Z coordinate positions) to be determined. In one embodiment, computing devices 101 utilize various software tools for determining such user positions, including, but not limited to, OpenCV®, TensorFlow®, Keras®, PyTorch®, etc.

The user positions may be utilized to correctly render a virtual three-dimensional object on top of the object of interest (e.g., object of interest 402) as discussed below. That is, once a reference position for users is established, mobile computing device 101A (master) renders a virtual three-dimensional (3D) object on top of the object of interest 402 from a field of view of the master as discussed below.

In step 307, mobile computing device 101, such as the master (e.g., mobile computing device 101A), renders a virtual three-dimensional (3D) object on top of object of interest 402 as illustrated in FIG. 5.

FIG. 5 illustrates rendering a virtual three-dimensional object on top of the object of interest by the master which is shared with the slave as a quadtree data structure in accordance with an embodiment of the present invention.

As shown in FIG. 5, FIG. 5 illustrates the master (e.g., mobile computing device 101A) rendering a virtual three-dimensional object 501 (e.g., dog) on top of the object of interest 402 (e.g., table) from a field of view of the master. In one embodiment, since the master (e.g., mobile computing device 101A) is the initiator, the virtual three-dimensional object is rendered at a 0° angle in the master's field of view.

In one embodiment, such a virtual three-dimensional object 501 (e.g., dog) is rendered on top of the object of interest 402 by the master using ray casting. Ray casting creates a three-dimensional render of an object (e.g., dog) by casting rays from the point of view of camera 213 (e.g., monocular camera) of the master (e.g., mobile computing device 101A). It transforms the data into a three-dimensional projection by tracing the rays from the point of view of the master (e.g., mobile computing device 101A). In one embodiment, with respect to ray casting, when the rays intersect an object, such as object of interest 402, the object's color and brightness at that point determine the value of one pixel in the final image (image with virtual three-dimensional object 501 on top of object of interest 402). In one embodiment, the master (e.g., mobile computing device 101A) utilizes various software tools for rendering virtual three-dimensional objects using ray casting, including, but not limited to, 3D Cloud, Adobe Dimension®, Unity3D, imagine.io, Vectorworks®, etc.

In another embodiment, virtual three-dimensional object 501 (e.g., dog) is rendered on top of the object of interest 402 by the master (e.g., mobile computing device 101A) using physically based rendering. In one embodiment, physically based rendering utilizes bidirectional scattering distribution functions to calculate the visible light reflected at a give point on the surface. In one embodiment, the master (e.g., mobile computing device 101A) utilizes various software tools for implementing physically based rendering, including, but not limited to, 3D Cloud, Adobe Dimension®, Unity3D, imagine.io, Vectorworks®, etc.

In one embodiment, the virtual three-dimensional object 501 to be rendered is selected from a list of objects, which may be presented to the user of the master (e.g., mobile computing device 101A), such as via display screen 212. The user of the master (e.g., mobile computing device 101A) may select one of these virtual three-dimensional objects to be displayed on top of the object of interest 402, such as via keypad 210 or the graphical user-interface on display 212 of the master (e.g., mobile computing device 101A). Upon selecting the virtual three-dimensional object to be rendered, the selected virtual three-dimensional object (e.g., dog) is rendered on top of object of interest 402 using various means, including, but not limited to, ray casting, physically based rendering, etc.

Returning to FIG. 3A, in conjunction with FIGS. 1-3 and 4-5, in step 308, the master (e.g., mobile computing device 101A) transforms the image with the rendered virtual three-dimensional (3D) object (e.g., virtual three-dimensional object 501) into a quadtree data structure 502 as shown in FIG. 5. A quadtree data structure, as used herein, refers to a tree data structure in which each internal node has exactly four children. Quadtrees are the two-dimensional analog of octrees and are used to partition a two-dimensional space by recursively subdividing it into four quadrants or regions. The data associated with a leaf cell varies by application, but the leaf cell represents a “unit of interesting spatial information.”

In one embodiment, the image with the rendered virtual three-dimensional (3D) object (e.g., virtual three-dimensional object 501) is transformed into quadtree data structure 502 from a raster or matrix by successively dividing the raster/matrix into smaller and smaller cells, where the decision on whether to divide a quadrant being determined by a function that checks the cell values within each quadrant and returns TRUE if it should be split, and FALSE otherwise. Initially, all of the cells in the raster are considered. If the cell values meet the condition determined by the splitting function, the raster is divided into four quadrants. Otherwise, the raster is not divided further and the value of this larger cell is calculated by applying a “combine function” that aggregates the cell values into a single value (e.g., mean, median, etc.). If a quadrant is split, the process is repeated for each of those “child” quadrants, and then for their children, and so on and so forth, until either the split function returns FALSE or the smallest possible cell size (as determined by the input raster) has been reached.

In one embodiment, mobile computing device 101, such as the master, transforms an image with the rendered virtual three-dimensional object (e.g., virtual three-dimensional object 501) into a quadtree data structure using various software tools, including, but not limited to, d3-quadtree, QuadTree, Quadtree module in SMS by Aquaveo®, etc.

In step 309, the master (e.g., mobile computing device 101A) shares the quadtree data structure 502 of step 308 with the slave (e.g., mobile computing device 101B), such as via P2P communication 503, as shown in FIG. 5. By sharing the image with the rendered virtual three-dimensional object as quadtree information, the communication overhead is reduced by ensuring a low data size. Furthermore, by communicating such information (e.g., quadtree information) via P2P, the costly 3D point clouds and cloud offloading are avoided.

In step 310, the slave (e.g., mobile computing device 101B) inputs the received quadtree data structure 502 into its machine learning model 504 to obtain rendering results (rendering results 602 as discussed further below) as illustrated in FIG. 5.

In step 311, the slave (e.g., machine learning model 101B) performs the rendering of the virtual three-dimensional object (e.g., dog, as represented by virtual three-dimensional object 505) on top of the object of interest 402 in the field of view of the slave using the rendering results (rendering results 602 as discussed further below) from machine learning model 504 of the slave as illustrated in FIG. 5.

Referring to FIG. 5, the slave inputs the received quadtree data structure 502 into machine learning model 504 of the slave in order to obtain rendering results. Such rendering results correspond to rendering the virtual three-dimensional object 501 in the field of view of the slave (e.g., mobile computing device 101B) corresponding to virtual three-dimensional object 505 based on the angular difference of its position in the real world from the master. However, the rendered virtual three-dimensional object 505 in the field of view of the slave (e.g., mobile computing device 101B) may experience a slight offset due to the movement of the users of mobile computing devices 101A, 101B, as shown in FIG. 5 in which the rendered virtual three-dimensional object 505 is slightly offset from the desired position, represented by a transparent object 506.

In one embodiment, machine learning model 504 corresponds to a machine learning model that utilizes a quadtree algorithm for real-time virtual three-dimensional object rendering.

In one embodiment, a machine learning algorithm, such as a software component of application 206 of mobile computing device 101, trains machine learning model 504 to render a virtual three-dimensional object, such as virtual three-dimensional object 505, based on quadtree data structures. In one embodiment, such a model (machine learning model 504) is built and trained using a sample data set that includes the virtual three-dimensional objects and the associated quadtree data structures. For example, such a sample data set may include various rendered virtual three-dimensional objects and the associated quadtree data structures. The position of such virtual three-dimensional objects is then determined based on the angular difference of the user's position (user of mobile computing device 101 in question) in the real world from the other mobile computing device 101. In one embodiment, such a sample data set is compiled by an expert.

Furthermore, such a sample data set is referred to herein as the “training data,” which is used by the machine learning algorithm to make predictions or decisions as to the estimated rendered virtual three-dimensional object based on quadtree data structures. The algorithm iteratively makes predictions of the estimated rendered virtual three-dimensional object until the predictions achieve the desired accuracy as determined by an expert. Examples of such learning algorithms include, but not limited to, nearest neighbor, Naïve Bayes, decision trees, linear regression, support vector machines, and neural networks.

Returning to FIG. 3A, in connection with FIGS. 1-2 and 4-5, in step 312, the slave (e.g., mobile computing device 101B) transforms the image with the rendered virtual three-dimensional (3D) object (e.g., virtual three-dimensional object 505) into a quadtree data structure 601 as shown in FIG. 6 (discussed further below). The slave (e.g., mobile computing device 101B) transforms the image with the rendered virtual three-dimensional (3D) object (e.g., virtual three-dimensional object 505) into a quadtree data structure 601 in the same manner as discussed above in connection with step 308.

Referring now to FIG. 3B, in conjunction with FIGS. 1-2 and 4-5, in step 313, the master (e.g., machine learning model 101A) receives the quadtree data structure 601 along with the machine learning results 602 (machine learning results from machine learning model 504) from the slave via peer-to-peer (P2P) communication 603 as illustrated in FIG. 6.

FIG. 6 illustrates the slave sharing the resulting rendered image as a quadtree data structure along with the machine learning results with the master in accordance with an embodiment of the present disclosure.

As shown in FIG. 6, the slave (e.g., mobile computing device 101B) shares quadtree data structure 601 along with the machine learning results 602 with the master (e.g., mobile computing device 101A) via peer-to-peer (P2) communication 603. By sharing the image with the rendered virtual three-dimensional object as quadtree information, the communication overhead is reduced by ensuring a low data size. Furthermore, by communicating such information (e.g., quadtree information) via P2P, the costly 3D point clouds and cloud offloading are avoided.

Returning to FIG. 3B, in conjunction with FIGS. 1-2 and 4-6, in step 314, the master (e.g., mobile computing device 101A) inputs the received quadtree data structure 601 and machine learning results 602 into its machine learning model 604 to obtain rendering results 702 as illustrated in FIGS. 6 and 7 (discussed further below).

In step 315, the master (e.g., mobile computing device 101A) receives the machine learning results (machine learning results 702) from machine learning model 604.

In step 316, the master (e.g., mobile computing device 101A) determines whether corrections need to be performed on the previously rendered virtual three-dimensional image 501 based on the machine learning results (machine learning results 702). In one embodiment, the machine learning results (machine learning results 702) include correction values which indicate the corrections to be performed (e.g., reposition previously rendered virtual three-dimensional object 501 from x, y, and z coordinates to x′, y′, and z′ coordinates) to the previously rendered virtual three-dimensional object 501, if necessary. Corrections using the correction values may include a repositioning of the previously rendered virtual three-dimensional object 501 forming three-dimensional object 501′ in the field of view of the master (e.g., mobile computing device 101A) as illustrated in FIG. 6. In one embodiment, corrections via correction values may only be made or recommended in the machine learning results (machine learning results 702) if the changes in the placement of the previously rendered virtual three-dimensional object 501 exceed a user-designated threshold. For example, corrections via correction values may only be made or recommended in the machine learning if the position of the previously rendered virtual three-dimensional object 501 needs to be adjusted by an amount that exceeds a user-designated threshold.

In one embodiment, machine learning model 604 functions in the same manner as machine learning model 504. In one embodiment, machine learning model 604 utilizes a quadtree algorithm for real-time virtual three-dimensional object rendering.

As discussed above, in one embodiment, a machine learning algorithm, such as a software component of application 206 of mobile computing device 101, trains machine learning model 604 to render a virtual three-dimensional object based on quadtree data structures. In one embodiment, such a model (machine learning model 604) is built and trained using a sample data set that includes the virtual three-dimensional objects and the associated quadtree data structures. For example, such a sample data set may include various rendered virtual three-dimensional objects and the associated quadtree data structures. The position of such virtual three-dimensional objects is then determined based on the angular difference of the user's position (user of mobile computing device 101 in question) in the real world from the other mobile computing device 101. In one embodiment, such a sample data set is compiled by an expert.

Furthermore, such a sample data set is referred to herein as the “training data,” which is used by the machine learning algorithm to make predictions or decisions as to the estimated rendered virtual three-dimensional object based on quadtree data structures. The algorithm iteratively makes predictions of the estimated rendered virtual three-dimensional object until the predictions achieve the desired accuracy as determined by an expert. Examples of such learning algorithms include, but not limited to, nearest neighbor, Naïve Bayes, decision trees, linear regression, support vector machines, and neural networks.

In one embodiment, after inputting the received quadtree data structure 601 and machine learning results 602 into its machine learning model 604, machine learning model 604 determines the rendering of the virtual three-dimensional object (e.g., dog) and any adjustment in its position based on the angular difference of the user's position (user of mobile computing device 101 in question) in the real world from the other mobile computing device 101.

If corrections do not need to be performed on the previously rendered virtual three-dimensional object (e.g., virtual three-dimensional object 501) based on the machine learning results (machine learning results 702), then, in step 317, corrections are not performed on the previously rendered virtual three-dimensional object in the previously rendered image.

If, however, corrections need to be performed on the previously rendered virtual three-dimensional object (e.g., virtual three-dimensional object 501) based on the machine learning results (machine learning results 702), then, in step 318, the master (e.g., mobile computing device 101A) updates the rendering of the image with the virtual three-dimensional object forming virtual three-dimensional object 501′ using the correction values from the machine learning results (machine learning results 702). In particular, the master (e.g., mobile computing device 101A) applies the corrections using the correction values to the previously rendered virtual three-dimensional object (e.g., virtual three-dimensional object 501) forming virtual three-dimensional object 501′ in the field of view of the master (e.g., mobile computing device 101A) as illustrated in FIGS. 6 and 7. In one embodiment, corrections via correction values may only be made or recommended in the machine learning results (machine learning results 702) if the changes in the placement of the previously rendered virtual three-dimensional object (e.g., virtual three-dimensional object 501) exceed a user-designated threshold. For example, corrections via correction values may only be made or recommended in the machine learning results (machine learning results 702) if the position of the previously rendered virtual three-dimensional object (e.g., virtual three-dimensional object 501) needs to be adjusted by an amount that exceeds a user-designated threshold.

In step 319, the master (e.g., mobile computing device 101A) transforms the updated image with the updated rendered virtual three-dimensional (3D) object (e.g., virtual three-dimensional object 501′) into a quadtree data structure 701 as shown in FIG. 7 (discussed further below).

In step 320, the master (e.g., mobile computing device 101A) shares the quadtree data structure 701 of step 319 along with the machine learning results 702 (results with the correction values) with the slave (e.g., mobile computing device 101B), such as via P2P communication 703, as shown in FIG. 7. By sharing the image with the rendered virtual three-dimensional object as quadtree information, the communication overhead is reduced by ensuring a low data size. Furthermore, by communicating such information (e.g., quadtree information) via P2P, the costly 3D point clouds and cloud offloading are avoided.

FIG. 7 illustrates the master applying corrections to the rendered image which is shared with the slave as a quadtrec data structure along with the machine learning results in accordance with an embodiment of the present disclosure.

Referring to FIG. 7, FIG. 7 illustrates the master (e.g., mobile computing device 101A) sharing the quadtree data structure 701 of step 319 along with the machine learning results 702 (results with the correction values) with the slave (e.g., mobile computing device 101B), such as via P2P communication 703.

Returning to FIG. 3B, in conjunction with FIGS. 1-2 and 4-7, upon receiving the quadtree data structure 701 and machine learning results 702, in step 321, the slave (e.g., mobile computing device 101B) inputs such information into machine learning model 504 in order to obtain rendering results 602 as discussed above in connection with step 310.

Upon inputting such information into machine learning model 504, the slave (e.g., machine learning model 101B) performs the rendering of the virtual three-dimensional object (e.g., virtual three-dimensional object 505) forming virtual three-dimensional object 505′ on top of the object of interest 402 using rendering results 602 from machine learning model 504 of the slave in step 311.

As discussed above, the iterative cycle discussed above continues until the machine learning results (see machine learning results 702) indicate that the changes in the placement of the previously rendered virtual three-dimensional object do not exceed a user-designated threshold as discussed above in connection with steps 316-317.

In this manner, the AR framework of the present disclosure reduces the latency and energy consumption while ensuring a smooth user experience by utilizing a lightweight machine learning model using a quadtree algorithm to process quadtree data structures as well as having the mobile computing devices communicate with one another via peer-to-peer communication. By implementing such a framework, the need for offloading tasks to the cloud (e.g., cloud server) is eliminated.

Furthermore, the principles of the present disclosure improve the technology or technical field involving augmented reality systems. As discussed above, a multi-user AR system allows multiple users to interact with virtual objects overlaid on real-world space. This has led to the development of various useful applications, such as multiplayer gaming, medical imaging, classroom education, navigation, robotics, autonomous vehicle, virtual exhibition in museums, etc. However, multi-user AR itself is a computation-intensive task requiring low latency and high accuracy for ensuring a smooth user experience. To address this challenge, the commercial multi-user AR frameworks, such as Google ARCore® and Apple ARKit®, utilize cloud services to offload computation-intensive tasks. This includes offloading three-dimensional (3D) point clouds required for localization of users through the simultaneous localization and mapping (SLAM) algorithm. However, using cloud services can cause noticeable delays in latency and communications overheads. The long delay causes inaccurate rendering results as the user's position may have changed during such a long processing time, and the user may see an object as per the user's previous position. As a result, current multi-user AR frameworks suffer from high latency and high energy consumption which diminish the AR user experience.

Embodiments of the present disclosure improve such technology by rendering a virtual three-dimensional object on top of an object of interest in a first image by a first mobile computing device (“master”). The first image is then transformed into a first quadtree data structure. The first quadtree data structure is then shared with a second mobile computing device (“slave”), such as via peer-to-peer communication, which inputs the first quadtree data structure into a machine learning model which utilizes a quadtree algorithm to obtain machine learning results which is used by the second mobile computing device (“slave”) to render a second image of the virtual three-dimensional object on top of the object of interest in the field of view of the second mobile computing device (“slave”), which may experience slight offset due to the movement of the users of the mobile computing devices in which the rendered virtual three-dimensional object is slightly offset from the desired position. The second mobile computing device (“slave”) then transforms the rendered second image into a second quadtree data structure, which is shared with the first mobile computing device (“master”) along with the machine learning results, such as via peer-to-peer communication. The first mobile computing device (“master”) then inputs the received second quadtree data structure and machine learning results into its machine learning model, which utilizes a quadtree algorithm. The machine learning results may then indicate whether corrections are to be applied to the image previously rendered by the first mobile computing device (“master”) which results in changes in the placement of the previously rendered virtual three-dimensional object. If such corrections need to be performed on the previously rendered image, then the first mobile computing device (“master”) updates the rendering of the image using correction values. The updated rendering of the image is then transformed into a third quadtree data structure, which is shared along with the machine learning results with the second mobile computing device (“slave”), such as via peer-to-peer communication. This iterative process continues until the machine learning results obtained by the first mobile computing device (“master”) indicate that the changes in the placement of the previously rendered virtual three-dimensional object do not exceed a user-designated threshold. In this manner, the AR framework of the present disclosure reduces the latency and energy consumption while ensuring a smooth user experience by utilizing a lightweight machine learning model using a quadtree algorithm to process quadtree data structures as well as having the mobile computing devices communicate with one another via peer-to-peer communication. Furthermore, in this manner, there is an improvement in the technical field involving augmented reality systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

In one embodiment of the present disclosure, a computer-implemented method for improving operational performance of a multi-user augmented reality system comprises transforming a first image with a virtual three-dimensional object into a first quadtree data structure. The method further comprises sharing the first quadtree data structure with a second computing device which is inputted into a machine learning model on the second computing device to obtain a first machine learning result which is used by the second computing device to render a second image of the virtual three-dimensional object. The method additionally comprises receiving the second image as a second quadtree data structure as well as the first machine learning result from the second computing device. Furthermore, the method comprises inputting the second quadtree data structure and the first machine learning result into a machine learning model on a first computing device to obtain a second machine learning result which includes correction values for modifying the first image. Additionally, the method comprises updating a rendering of the first image using the correction values.

Furthermore, in one embodiment of the present disclosure, the method additionally comprises transforming the updated rendered first image into a third quadtrec data structure. Additionally, the method comprises sharing the third quadtree data structure and the correction values with the second computing device which are inputted into the machine learning model on the second computing device to obtain a third machine learning result used to update the rendered second image to more accurately display the virtual three-dimensional object from a field of view of the second computing device.

Additionally, in one embodiment of the present disclosure, the method further comprises receiving the updated second image as a fourth quadtree data structure as well as the third machine learning result from the second computing device. Furthermore, the method comprises inputting the fourth quadtree data structure and the third machine learning result into the machine learning model on the first computing device to obtain a fourth machine learning result.

Furthermore, in one embodiment of the present disclosure, the method additionally comprises determining whether to perform additional corrections to the updated first image based on the fourth machine learning result.

Additionally, in one embodiment of the present disclosure, the method further comprises receiving a selection of a reference object and an object of interest. Furthermore, the method comprises identifying an angle and a distance between the first computing device and the reference object as well as the object of interest. The method additionally comprises performing triangulation by the first computing device using the identified angle and the distance between the first computing device and the reference object as well as the object of interest to obtain user localization values.

Furthermore, in one embodiment of the present disclosure, the method additionally comprises comparing the user localization values from the first computing device with user localization values obtained from the second computing device to identify a position of users of the first and second computing devices.

Additionally, in one embodiment of the present disclosure, the method further comprises rendering the virtual three-dimensional object on top of the object of interest of the first image by the first computing device from a field of view of the first computing device based on the identified position of the user of the first computing device.

Furthermore, in one embodiment of the present disclosure, the method additionally comprises rendering the virtual three-dimensional object on top of the object of interest of the second image by the second computing device from a field of view of the second computing device based on the identified position of the user of the second computing device.

Additionally, in one embodiment of the present disclosure, the first quadtree data structure is shared with the second computing device by the first computing device using peer-to-peer communication, where the second quadtree data structure as well as the first machine learning result is received by the first computing device from the second computing device using the peer-to-peer communication.

Furthermore, in one embodiment of the present disclosure, the first image is captured by the first computing device using a monocular camara.

Additionally, in one embodiment of the present disclosure, the machine learning models on the first and second computing devices utilize a quadtree algorithm for real-time virtual three-dimensional object rendering.

Other forms of the embodiments of the method described above are in a system and in a computer program product.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for improving operational performance of a multi-user augmented reality system, the method comprising:
transforming a first image with a virtual three-dimensional object into a first quadtree data structure;
sharing said first quadtree data structure with a second computing device which is inputted into a machine learning model on said second computing device to obtain a first machine learning result which is used by said second computing device to render a second image of said virtual three-dimensional object;
receiving said second image as a second quadtree data structure as well as said first machine learning result from said second computing device;
inputting said second quadtree data structure and said first machine learning result into a machine learning model on a first computing device to obtain a second machine learning result which includes correction values for modifying said first image; and
updating a rendering of said first image using said correction values.

2. The method as recited in claim 1 further comprising:
transforming said updated rendered first image into a third quadtree data structure; and
sharing said third quadtree data structure and said correction values with said second computing device which are inputted into said machine learning model on said second computing device to obtain a third machine learning result used to update said rendered second image to more accurately display said virtual three-dimensional object from a field of view of said second computing device.

3. The method as recited in claim 2 further comprising:
receiving said updated second image as a fourth quadtree data structure as well as said third machine learning result from said second computing device; and
inputting said fourth quadtree data structure and said third machine learning result into said machine learning model on said first computing device to obtain a fourth machine learning result.

4. The method as recited in claim 3 further comprising:
determining whether to perform additional corrections to said updated first image based on said fourth machine learning result.

5. The method as recited in claim 1 further comprising:
receiving a selection of a reference object and an object of interest;
identifying an angle and a distance between said first computing device and said reference object as well as said object of interest; and
performing triangulation by said first computing device using said identified angle and said distance between said first computing device and said reference object as well as said object of interest to obtain user localization values.

6. The method as recited in claim 5 further comprising:
comparing said user localization values from said first computing device with user localization values obtained from said second computing device to identify a position of users of said first and second computing devices.

7. The method as recited in claim 6 further comprising:
rendering said virtual three-dimensional object on top of said object of interest of said first image by said first computing device from a field of view of said first computing device based on said identified position of said user of said first computing device.

8. The method as recited in claim 6 further comprising:
rendering said virtual three-dimensional object on top of said object of interest of said second image by said second computing device from a field of view of said second computing device based on said identified position of said user of said second computing device.

9. The method as recited in claim 1, wherein said first quadtree data structure is shared with said second computing device by said first computing device using peer-to-peer communication, wherein said second quadtree data structure as well as said first machine learning result is received by said first computing device from said second computing device using said peer-to-peer communication.

10. The method as recited in claim 1, wherein said first image is captured by said first computing device using a monocular camara.

11. The method as recited in claim 1, wherein said machine learning models on said first and second computing devices utilize a quadtree algorithm for real-time virtual three-dimensional object rendering.

12. A computer program product for improving operational performance of a multi-user augmented reality system, the computer program product comprising one or more computer readable storage mediums having program code embodied therewith, the program code comprising programming instructions of a computer-implemented method of comprising:
transforming a first image with a virtual three-dimensional object into a first quadtree data structure;
sharing said first quadtree data structure with a second computing device which is inputted into a machine learning model on said second computing device to obtain a first machine learning result which is used by said second computing device to render a second image of said virtual three-dimensional object;
receiving said second image as a second quadtree data structure as well as said first machine learning result from said second computing device;
inputting said second quadtree data structure and said first machine learning result into a machine learning model on a first computing device to obtain a second machine learning result which includes correction values for modifying said first image; and
updating a rendering of said first image using said correction values.

13. A system, comprising:
a memory for storing a computer program for improving operational performance of a multi-user augmented reality system; and
a processor connected to the memory, wherein the processor is configured to execute program instructions of the computer program of a computer-implemented method comprising:
transforming a first image with a virtual three-dimensional object into a first quadtree data structure;
sharing said first quadtree data structure with a second computing device which is inputted into a machine learning model on said second computing device to obtain a first machine learning result which is used by said second computing device to render a second image of said virtual three-dimensional object;
receiving said second image as a second quadtree data structure as well as said first machine learning result from said second computing device;
inputting said second quadtree data structure and said first machine learning result into a machine learning model on a first computing device to obtain a second machine learning result which includes correction values for modifying said first image; and
updating a rendering of said first image using said correction values.
